(19) United States
(12) Patent Application Publication
(10) Pub. No.: US 2023/0292360 A1
(43) Pub. Date: Sep. 14, 2023

(54) TECHNIQUES FOR CHANNEL ACCESS FOR SIDELINK HYBRID AUTOMATIC REPEAT REQUEST FEEDBACK TRANSMISSION IN UNLICENSED SPECTRUM

(71) Applicant: QUALCOMM Incorporated, San Diego, CA (US)

(72) Inventors: Shuanshuan WU, San Diego, CA (US); Arthur GUBESKYS, San Diego, CA (US); Juan MONTOJO, San Diego, CA (US); Stelios STEFANATOS, San Diego, CA (US); Parisa CHERAGHI, Cambridge (GB)

(21) Appl. No.: 18/017,316

(22) PCT Filed: Sep. 28, 2021
(86) PCT No.: PCT/US2021/052443

§ 371 Date: Jan. 20, 2023

(30) Foreign Application Priority Data
Sep. 29, 2020 (GR) 20200100591

(51) Int. Cl. H04W 74/00; H04L 1/1829; H04W 72/0446

(52) U.S. Cl. CPC H04W 74/002; H04L 1/1854; H04L 1/1861; H04W 72/0446

(57) ABSTRACT

Channel access for sidelink hybrid automatic repeat request (HARQ) feedback transmission in unlicensed spectrum may be performed. A receiving UE may receive a first transmission from a transmitting UE, and, upon reception of a second transmission from the transmitting UE, may transmit a HARQ feedback transmission to the transmitting UE to indicate decoding of the first transmission. Techniques described herein allow coordination between the receiving UE and the transmitting UE for consistent HARQ feedback in the unlicensed spectrum.

### CROSS-REFERENCE TO RELATED APPLICATION(S)

This application claims the benefit of Greek Application Serial No. 20200100591, entitled “TECHNIQUES FOR CHANNEL ACCESS FOR SIDELINK HYBRID AUTOMATIC REPEAT REQUEST FEEDBACK TRANSMISSION IN UNLICENSED SPECTRUM” and filed on Sep. 29, 2020, which is expressly incorporated by reference herein in its entirety.

### BACKGROUND

Aspects of the present disclosure relate generally to wireless communications, and more particularly, to apparatuses and methods for techniques for channel access for sidelink hybrid automatic repeat request (HARQ) feedback transmission in unlicensed spectrum.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

### SUMMARY

Systems, methods, and apparatus presented herein each have several innovative aspects, no single one of which is solely responsible for the desirable attributes disclosed herein. The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of wireless communication by a user equipment (UE) is provided. The method may include receiving, from a device, a first transmission in a first slot. The method may also include preparing, in response to the first transmission being received, a feedback message indicating decoding of the first transmission. The method may also include determining a feedback resource of a subsequent slot to the first slot to transmit the feedback message. The method may also include transmitting, to the device, the feedback message in the feedback resource of the subsequent slot.

In another aspect, a method of wireless communication by a user equipment (UE) is provided. The method may include determining a first slot to transmit a first transmission and a subsequent slot to the first slot to transmit a second transmission. The method may also include transmitting, to a device, the first transmission in the first slot. The method may also include transmitting, to the device, the second transmission in the subsequent slot. The method may also include receiving, from the device in response to the first transmission being transmitted, a feedback message in a feedback resource of the subsequent slot or another subsequent slot to the first slot, the feedback message indicating decoding of the first transmission.

In another aspect, a UE including a memory storing instructions and one or more processors coupled with the memory is provided. The one or more processors may include receive, from a device, a first transmission in a first slot. The one or more processors may include prepare, in response to the first transmission being received, a feedback message indicating decoding of the first transmission. The one or more processors may include determine a feedback resource of a subsequent slot to the first slot to transmit the feedback message. The one or more processors may include transmit, to the device, the feedback message in the feedback resource of the subsequent slot.

In another aspect, a UE including a memory storing instructions and one or more processors coupled with the memory is provided. The one or more processors may include determine a first slot to transmit a first transmission and a subsequent slot to the first slot to transmit a second transmission. The one or more processors may include transmit, to a device, the first transmission in the first slot. The one or more processors may include transmit, to the device, the second transmission in the subsequent slot. The one or more processors may include receive, from the device in response to the first transmission being transmitted, a feedback message in a feedback resource of the subsequent slot or another subsequent slot to the first slot, the feedback message indicating decoding of the first transmission.

In other aspects, apparatus configured to perform one or more methods herein are provided. In other aspects, computer readable mediums having instructions that cause one or more processors to perform one or more methods herein are provided. In other aspects, apparatus having means for performing one or more methods herein are provided.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network, according to aspects of the present disclosure;

FIG. 2 is a schematic diagram of an example of a user equipment (UE) of FIG. 1, according to aspects of the present disclosure;

FIG. 3 is a block diagram of an example series of slot formats, according to aspects of the present disclosure;

FIG. 4 is block diagrams of conceptual examples of resource allocation, according to aspects of the present disclosure;

FIG. 5 is block diagram of an example feedback technique, according to aspects of the present disclosure;

FIG. 6 is block diagram of another example feedback technique, according to aspects of the present disclosure;

FIG. 7 is flow diagram of an example method performed by a receiving user equipment (UE) of FIG. 1, according to aspects of the present disclosure;

FIG. 8 is a flow diagram of another example method performed by the receiving UE of FIG. 1, according to aspects of the present disclosure;

FIG. 9 is a flow diagram of another example method performed by the receiving UE of FIG. 1, according to aspects of the present disclosure; and

FIG. 10 is flow diagram of an example method performed by a transmitting UE of FIG. 1, according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Conventionally, new radio (NR) vehicle-to-everything (V2X) sidelink designs use licensed spectrums such as shared cellular bands or dedicated spectrum for intelligent transportation system (ITS) for communications. However, licensed spectrums may not be guaranteed in some regions. In these situations, NR V2X may use unlicensed spectrum shared by other technologies (e.g., Wi-Fi) to obtain additional bandwidth not provided by the licensed spectrum.

Unlicensed spectrums may be subject to regulatory requirements. One of the requirements is listen-before-talk (LBT) techniques requiring a device to perform sensing (e.g., listen) before the device can transmit (e.g., talk). In LBT, a device may measure energy in a band and transmit if the energy is below a threshold. LBT includes different types of regulations including, for example, category (CAT) 2 LBT, which does not include random back-off, and CAT 4 LBT, which includes random back-off with a contention window of variable size. However, use of LBT may create uncertainty and add time delays for acknowledging data transmissions.

The present disclosure provides techniques for channel access for sidelink hybrid automatic repeat request (HARQ) feedback transmission in unlicensed spectrum, which may reduce LBT failure probability for HARQ feedback transmissions.

In more detail, NR V2X sidelink HARQ feedback mechanisms in licensed spectrums may include, for example, a first user equipment (UE1) that transmits a data channel, a second UE (UE2) that receives the transmission and sends an acknowledgment/negative acknowledgment (ACK/NACK) to indicate whether the data is successfully decoded. HARQ feedback transmissions may occur in a configured or pre-configured physical sidelink feedback channel (PSFCH) resource, which occurs in every N slots (N=0, 1, 2, 4), where for example N=0 means no feedback, N=1 means feedback opportunity in every slot (e.g., every slot has a resource configured for HARQ feedback transmission), N=2 means feedback opportunity in every other slot, and N=4 means feedback opportunity in every 4 slots.

The resource used for HARQ feedback transmission corresponding to a physical sidelink scheduling channel (PSSCH) may be determined based on a time and a frequency location of the transmission and a transmitter UE identification (ID), and a receiver UE ID if the HARQ feedback is for ACK/NACK based groupcast communications.

In the current NR V2X, each HARQ feedback may be transmitted in one physical resource block (PRB) and two orthogonal frequency division multiplexing (OFDM) symbols in the PSFCH resource. In an example, there may be multiple PSFCH resources configured corresponding to a PSSCH transmission. In an example, multiple resources may be used for groupcast ACK/NACK feedback, so different receiving UEs in the group may transmit feedback in different PSFCH resources. In another example, it may be possible that multiple transmitting UEs transmit data in a same resource (e.g., data collision) and/or multiple HARQ resource mappings may alleviate HARQ collisions.

In an aspect, NR V2X for licensed spectrums may support autonomous resource allocation (e.g., Mode 2). In this example, a UE can access the channel based on its sensing outcomes. Specifically, the UE may first identify available resources for its sidelink transmission (e.g., candidate resources). The UE may then select resources for transmissions from the candidate resources. Resource selection and reservation in autonomous resource allocation may include reservations of up to two future resources, in addition to a current resource, for the UE's transmission (e.g., for re-transmission of a packet) when transmitting the current transmission. For resource reservation, the UE may select resources from candidate resources. When transmitting a PSSCH, the UE's sidelink control indicator (SCI) transmission may indicate resource allocation for the current transmission. The SCI also may indicate one or more future resources, which can be used by the UE to perform retransmission(s) or to transmit different data packets. In some examples, the resource reservations can be chained.

In an aspect, NR-unlicensed (NR-U) may specify a Type 1 or a Type 2 channel access type. In the Type 1 channel access, time duration spanned by the sensing slots that are sensed to be idle before a transmission(s) may be random (e.g., CAT 4 LBT). In the Type 2 channel access, time duration spanned by sensing slots that are sensed to be idle before a transmission(s) is determined based on a Type 2A having a sensing duration of 25 microseconds (μs), a Type 2B having a sensing duration of 16 μs, or a Type 2C having no sensing duration (e.g., may be applied when a gap between two transmissions is no larger than 16 us). Typically, Type 2 channel access requires less operations than a Type 1 channel access.

In another aspect of NR-U, a base station may initiate a channel occupancy type (COT) or channel occupancy (CO) based on a Type 1 channel access. A UE may share the COT, such that the UE may perform Type 2 channel access before intended transmissions, and the UE may transmit if the Type 2 channel access is successful.

In an aspect, HARQ feedback-based retransmissions may improve system performance. For example, retransmission(s) may guarantee that a packet is delivered to intended receivers. Compared to blind retransmission, HARQ feedback-based retransmission improves spectral efficiency. However, for sidelink communication in the unlicensed spectrum, HARQ feedback transmission may be subject to availability of the channel. For example, a transmitting UE may transmit a transport block (TB) or data transmission in slot n. A receiving UE may not be able to transmit feedback until slot n+k, where k is number slots needed for a processing time of the receiving UE. When k>=1, there may be a gap between a data transmission and a HARQ feedback transmission. By regulation, the receiving UE may be required to perform LBT before the HARQ feedback transmission if the gap is larger than a threshold, as the receiving UE cannot assume the medium is still idle. For example, the receiving UE may need to perform CAT 4 LBT (e.g., type 1 channel access) if the gap is larger than 25 μs. The uncertainty of the availability of the channel may largely compromise the improvements and benefits of using HARQ feedback.

Accordingly, this present disclosure proposes HARQ feedback techniques that may improve the availability of the medium for HARQ feedback transmission, while, at the same time, without requiring the reduction of the receiving UE processing time.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Turning now to the figures, examples of systems, apparatus, and methods for channel access for sidelink HARQ feedback transmissions in unlicensed spectrum are depicted. It is to be understood that aspects of the figures may not be drawn to scale and are instead drawn for illustrative purposes.

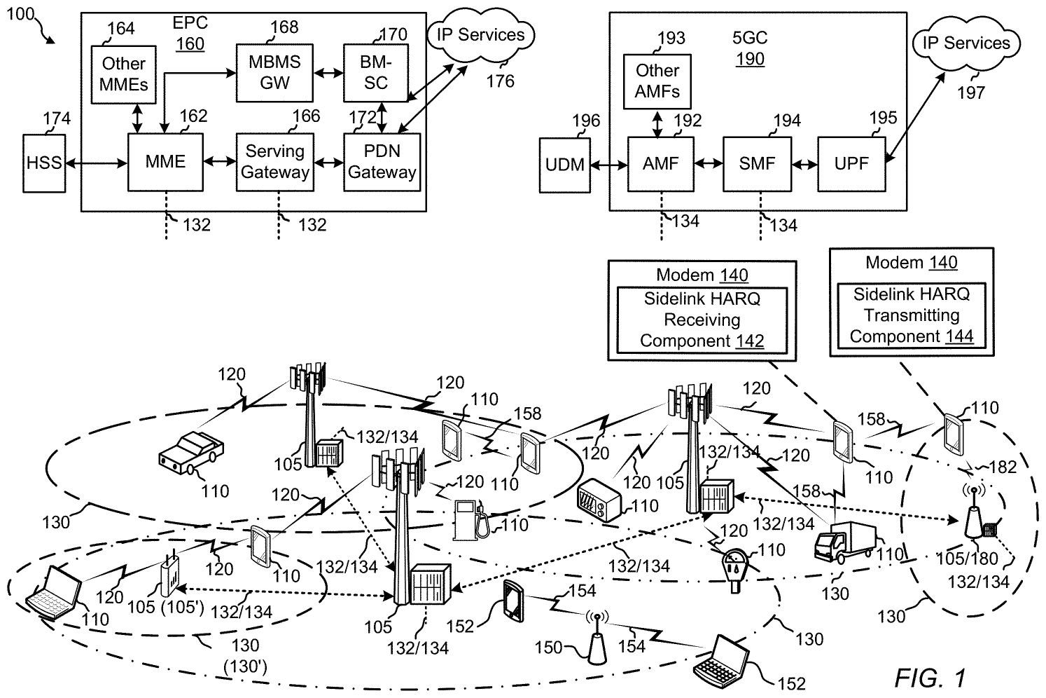

FIG. 1 is a diagram illustrating an example of a wireless communications system and an access network 100. The wireless communications system (also referred to as a wireless wide area network (WWAN)) includes at least one base station 105, UEs 110, an Evolved Packet Core (EPC) 160, and a 5G Core (5GC) 190. The base station 105 may include macro cells (high power cellular base station) and/or small cells (low power cellular base station). The macro cells include base stations. The small cells include femtocells, picocells, and microcells.

In some implementations, a UE 110 may include a modem 140, a sidelink HARQ receiving component 142, and/or a sidelink HARQ transmitting component 144 for channel access for sidelink HARQ feedback transmissions in an unlicensed spectrum.

A base station 105 may be configured for 4G LTE (collectively referred to as Evolved Universal Mobile Telecommunications System (UMTS) Terrestrial Radio Access Network (RAN) (E-UTRAN)) may interface with the EPC 160 through backhaul links interfaces 132 (e.g., S1, X2, Internet Protocol (IP), or flex interfaces). A base station 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the base station 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base station 105 may communicate directly or indirectly (e.g., through the EPC 160 or 5GC 190) with each other over the backhaul links interfaces 134. The backhaul links 132, 134 may be wired or wireless.

The base station 105 may wirelessly communicate with the UEs 110. Each of the base station 105 may provide communication coverage for a respective geographic coverage area 130. There may be overlapping geographic coverage areas 130. For example, the small cell 105′ may have a coverage area 130′ that overlaps the coverage area 130 of one or more macro base station 105. A network that includes both small cell and macro cells may be known as a heterogeneous network. A heterogeneous network may also include Home Evolved Node base station (eNBs) (HeNBs), which may provide service to a restricted group known as a closed subscriber group (CSG). The communication links 120 between the base station 105 and the UEs 110 may include uplink (UL) (also referred to as reverse link) transmissions from a UE 110 to a base station 105 and/or downlink (DL) (also referred to as forward link) transmissions from a base station 105 to a UE 110. The communication links 120 may use multiple-input and multiple-output (MIMO) antenna technology, including spatial multiplexing, beamforming, and/or transmit diversity. The communication links may be through one or more carriers. The base station 105/UEs 110 may use spectrum up to Y MHz (e.g., 5, 10, 15, 20, 100, 400, etc. MHz) bandwidth per carrier allocated in a carrier aggregation of up to a total of Yₓ MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A base station 105, whether a small cell 105′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 110. When the gNB 180 operates in mmW or near mmW frequencies, the gNB 180 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base station 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The base station 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

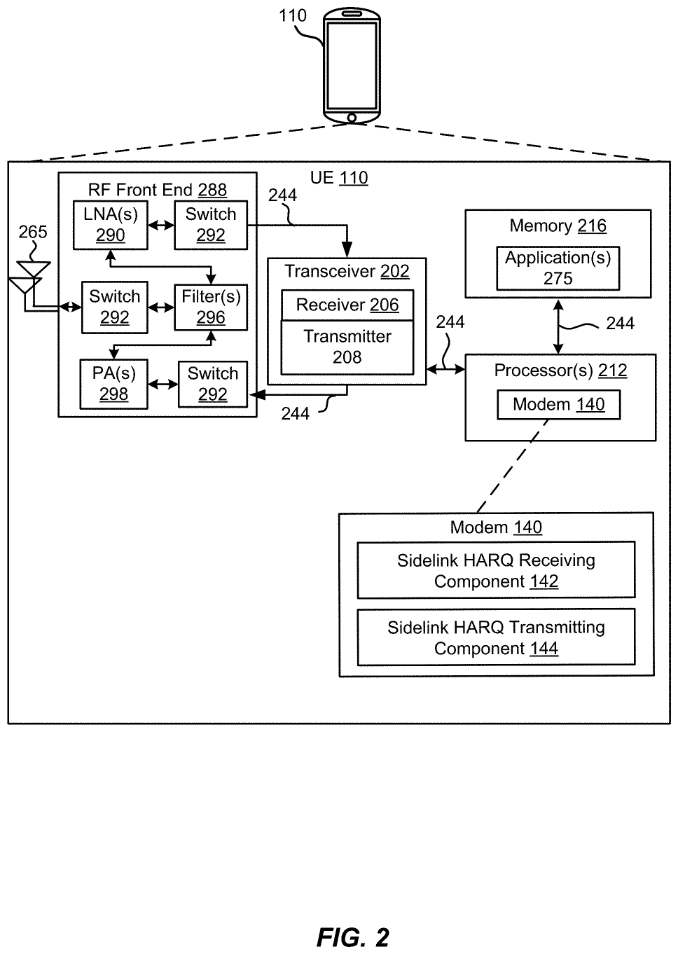

Referring to FIG. 2, an example implementation of the UE 110 may include the modem 140 having the sidelink HARQ receiving component 142 (e.g., for UE 110 to perform receiving UE functions) and/or the sidelink HARQ transmitting component 144 (e.g., for UE 110 to perform transmitting UE functions). The modem 140, the sidelink HARQ receiving component 142, and/or the sidelink HARQ transmitting component 144 of the UE 110 may be configured to manage communications with other UEs 110 via a cellular network, a Wi-Fi network, or other wireless and wired networks using licensed and unlicensed spectrums.

In some implementations, the UE 110 may include a variety of components, including components such as one or more processors 212 and memory 216 and transceiver 202 in communication via one or more buses 244, which may operate in conjunction with the modem 140, the sidelink HARQ receiving component 142, and/or the sidelink HARQ transmitting component 144 to enable one or more of the functions described herein related sidelink HARQ transmissions. Further, the one or more processors 212, modem 140, memory 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 140 that uses one or more modem processors. The various functions related to the sidelink HARQ receiving component 142 and/or the sidelink HARQ transmitting component 144 may be included in the modem 140 and/or the processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 140 may configure the UE 110 along with the processors 212. In other aspects, some of the features of the one or more processors 212 and/or the modem 140 associated with the sidelink HARQ receiving component 142 and/or the sidelink HARQ transmitting component 144 may be performed by the transceiver 202.

Also, the memory 216 may be configured to store data used herein and/or local versions of applications 275 or the sidelink HARQ receiving component 142 and/or the sidelink HARQ transmitting component 144 and/or one or more subcomponents of the sidelink HARQ receiving component 142 and/or the sidelink HARQ transmitting component 144 being executed by at least one processor 212. The memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, the memory 216 may be a non-transitory computer-readable storage medium that stores one or more computer-executable codes defining the sidelink HARQ receiving component 142 and/or the sidelink HARQ transmitting component 144 and/or one or more of its subcomponents, and/or data associated therewith, when the UE 110 is operating at least one processor 212 to execute the sidelink HARQ receiving component 142 and/or the sidelink HARQ transmitting component 144 and/or one or more of the subcomponents.

The transceiver 202 may include at least one receiver 206 and at least one transmitter 208. The receiver 206 may include hardware, firmware, and/or software code executable by a processor for receiving data, the code comprising instructions and being stored in a memory (e.g., computer-readable medium). The receiver 206 may be, for example, an RF receiving device. In an aspect, the receiver 206 may receive signals transmitted by at least one base station 105. The transmitter 208 may include hardware, firmware, and/or software code executable by a processor for transmitting data, the code comprising instructions and being stored in a memory (e.g., computer-readable medium). A suitable example of the transmitter 208 may include, but is not limited to, an RF transmitter.

Moreover, in an aspect, the UE 110 may include the RF front end 288, which may operate in communication with one or more antennas 265 and the transceiver 202 for receiving and transmitting radio transmissions, for example, wireless communications transmitted by at least one base station 105 or wireless transmissions transmitted by the UE 110. The RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, the LNA 290 may amplify a received signal at a desired output level. In an aspect, each of the LNAs 290 may have a specified minimum and maximum gain values. In an aspect, the RF front end 288 may use one or more switches 292 to select a particular LNA 290 and the specified gain value based on a desired gain value for a particular application.

Further, for example, one or more PA(s) 298 may be used by the RF front end 288 to amplify a signal for an RF output at a desired output power level. In an aspect, each of the PAs 298 may have specified minimum and maximum gain values. In an aspect, the RF front end 288 may use one or more switches 292 to select a particular PA 298 and the specified gain value based on a desired gain value for a particular application.

Also, for example, one or more filters 296 may be used by the RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, the RF front end 288 may use one or more switches 292 to select a transmit or receive path using a specified filter 296, the LNA 290, and/or the PA 298, based on a configuration as specified by the transceiver 202 and/or processor 212.

As such, the transceiver 202 may be configured to transmit and receive wireless signals through one or more antennas 265 via the RF front end 288. In an aspect, the transceiver 202 may be tuned to operate at specified frequencies such that the UE 110 may communicate with, for example, one or more of the base stations 105 or one or more cells associated with one or more of the base stations 105. In an aspect, for example, the modem 140 may configure the transceiver 202 to operate at a specified frequency and power level based on a UE configuration of the UE 110 and the communication protocol used by the modem 140.

In an aspect, the modem 140 may be a multiband-multimode modem, which may process digital data and communicate with the transceiver 202 such that the digital data is sent and received using the transceiver 202. In an aspect, the modem 140 may be multiband and be configured to support multiple frequency bands for a specific communications protocol. In an aspect, the modem 140 may be multimode and be configured to support multiple operating networks and communications protocols. In an aspect, the modem 140 may control one or more components of the UE 110 (e.g., RF front end 288, transceiver 202) to enable transmission and/or reception of signals from the network based on a specified modem configuration. In an aspect, a modem configuration may be based on the mode of the modem 140 and the frequency band in use. In another aspect, the modem configuration may be based on UE configuration information associated with the UE 110 as provided by the network (e.g., base station 105).

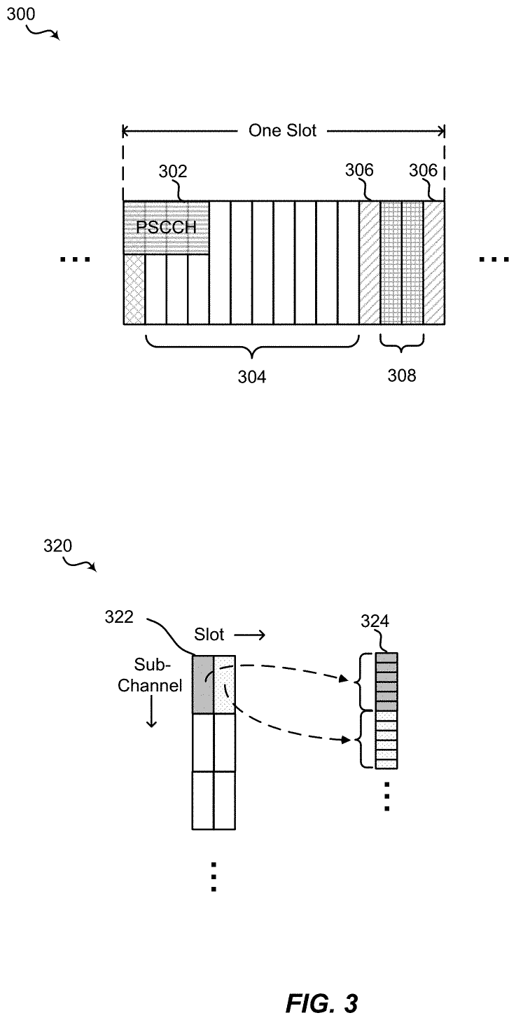

Referring to FIG. 3, a single slot format 300 for an NR V2X communication is provided. In an example, the slot format 300 may include 14 symbols including a portion for the PSCCH 302 used, for example, for carrying control signals, a portion for the PSSCH 304 used, for example, for carrying data signals, one or more gaps 306, and the PSFCH 308 used, for example, for carrying HARQ ACK/NACK feedback messages. Each slot 322 of a plurality of slots 320 may be divided into frequency PRBs 324 or sub-channels, and PSFCH resources in a PSFCH slot 322 may consist of a set of PRBs 324. In NR V2X, one PSFCH may be transmitted using one PRB, with a certain code domain resource (e.g., cyclic shift (CS)).

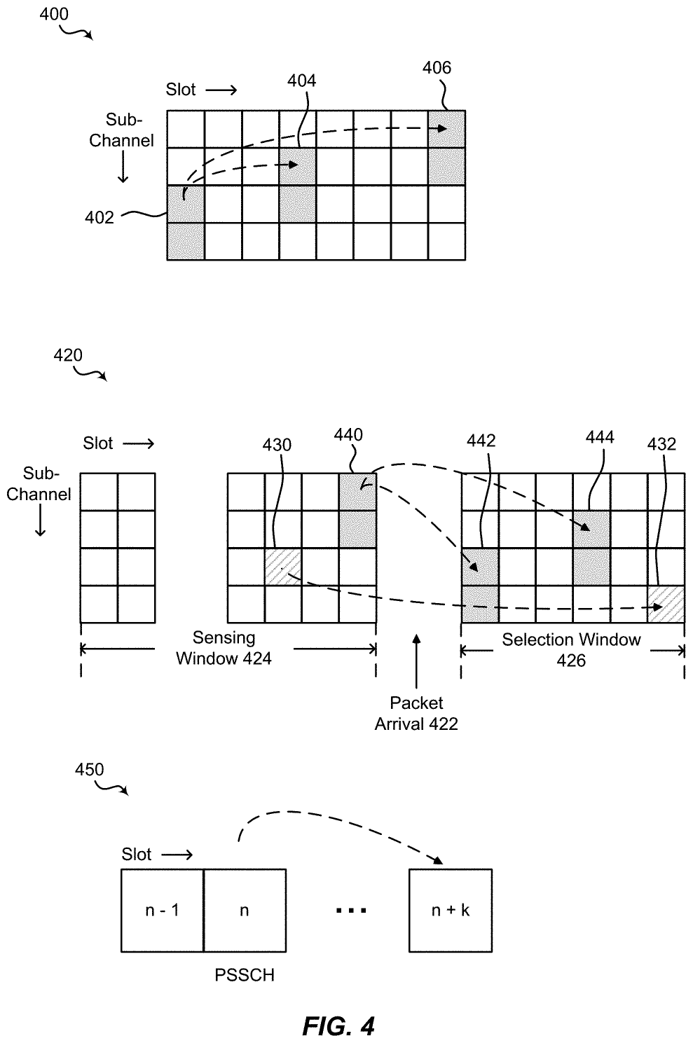

Referring to FIG. 4, an example of resource allocation 400 illustrates that a first resource 402 transmitted by a transmitting UE 110 may indicate one or more future resources 404 and 406 for communications between the transmitting UE 110 and the receiving UE 110.

In another example of resource allocation 420, a UE 110 may have a packet 422 arrival for transmission and look back to resources included in a sensing window 424 to determine when the UE 110 can transmit the packet 422. The sensing window 424 may be a predetermined time corresponding to previously received slots including slots 430 and 440. The UE 110 looks at the sensing window 424 to determine one or more future slots in a selection window 426 that the transmitting UE 110 has already scheduled for communications. The UE 110 may select one or more resources (e.g., slot 432—which corresponds to slot 430; and slots 442, 444—which correspond to slot 440) from the available resources to transmit the packet 422.

In another example of resource allocation 450, the receiving UE 110 may receive a transmission in slot n, where n is a whole number, but may not be able to transmit feedback until slot n+k, where k is a number of slots corresponding to the processing time of the receiving UE 110 to decode the transmission. As previously described, in some situations gaps between transmissions and feedback may require LBT according to unlicensed spectrum regulations. However, the LBT may introduce uncertainty in the feedback techniques and thereby reduce the benefits of using feedback techniques such as HARQ.

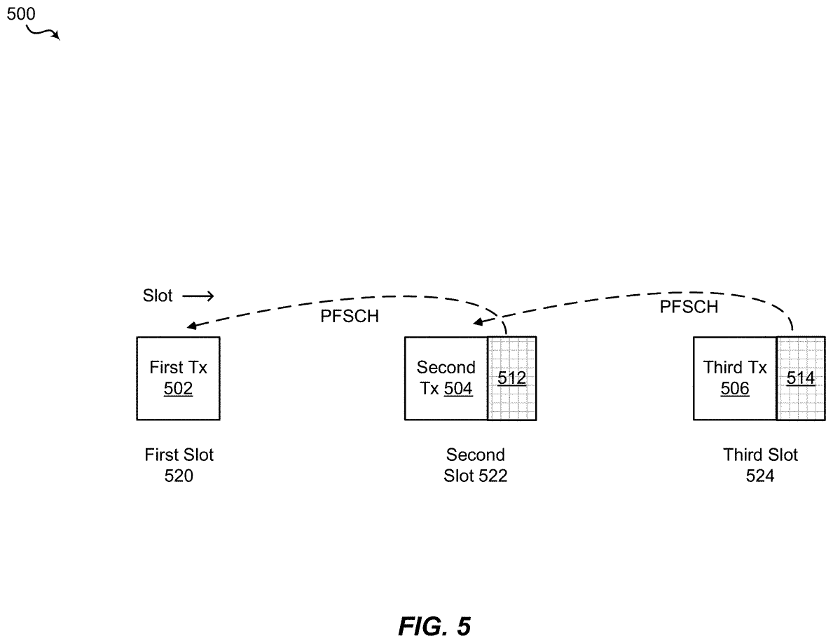

Referring to FIG. 5, an example of a feedback technique 500 used between a receiving UE 110 and a transmitting UE 110 is disclosed. In an aspect, for a sidelink data receiving UE 110, HARQ feedback acknowledging a transport block (TB) transmitted by a transmitting UE 110 in slot n is transmitted in slot n+k, where the slot n+k corresponds to one of the following options: option 1, the slot n+k is a slot indicated by the transmitting UE 110 in slot n, in which the transmitting UE 110 reserves a resource (e.g., for retransmission of the same TB, or for transmission of a new TB); option 2, the slot n+k is a slot used by the transmitting UE 110 to transmit a signal to request or trigger HARQ feedback transmission for the data transmitted in slot n; and option 3, the slot n+k is a slot determined by HARQ feedback timeline, the receiving UE 110 transmits HARQ feedback in slot n+k if the HARQ feedback transmission has been requested or enabled by the transmitting UE 110, and, another transmission from the transmitting UE 110 has been detected in slot n+k.

Regarding option 1, the transmitting UE 110 may indicate a future slot or a resource reservation in the future slot for a next transmission to the receiving UE 110. In this example, the transmitting UE 110 indicates or implies which future slot and/or resource of the future slot that the receiving UE 110 should use for transmission of feedback in a first transmission.

The resource reservation may be for retransmission of the TB, or a new TB transmission by the transmitting UE 110. The receiving UE 110 may determine whether the transmission in the reserved resource has been detected. When transmitting in slot n, the transmitting UE 110 also may indicate a resource reservation in slot n+k. The receiving UE 110 may transmit a HARQ feedback in slot n+k if the transmitting UE 110 transmits in slot n+k, otherwise the CAT 4 LBT may not be waived by regulation. Alternatively, the transmission by the transmitting UE 110 in slot n+k may not happen (e.g., when transmitting UE 110 fails LBT). The HARQ feedback may acknowledge the data transmission in a previous slot. For example, as illustrated by FIG. 5, the transmitting UE 110 may transmit a first transmission 502 in a first slot 520 (e.g., slot n), and the HARQ feedback 512 from the receiving UE 110 may be sent following a second transmission 504 in a second slot 522. The HARQ feedback 512 indicates the decoding outcome by the receiving UE 110 of the first transmission 502. In this example, the HARQ feedback 512 is transmitted in the same slot, the second slot (e.g., n+k), following the second transmission 504. Similarly, HARQ feedback 514 following a third transmission 506 from the transmitting UE 110 may be generated and transmitted by the receiving UE 110 in the third slot 524, where the HARQ feedback 514 indicates to the transmitting UE 110 the decoding outcome of the second transmission 504 by the receiving UE 110. In this example, the second slot 522 is slot n and the HARQ feedback 512 is transmitted in the same slot, the third slot 524 which is slot n+k, following the second transmission 504.

In some examples, the transmitting UE 110 may enable or request HARQ feedback from the receiving UE 110. The request may be transmitted by the transmitting UE 110 in a control signal or indicated in a prior transmission. The transmitting UE 110 may indicate that HARQ feedback is enabled; this can be indicated, for example, when transmitting the data in slot n, and/or, it can be indicated when transmitting a data in slot n+k.

Regarding option 2, the HARQ feedback transmission slot or resources may be indicated after a transmission is received. In this option, the transmitting UE 110 may or may not initially provide a future slot and/or a resource of the future slot to the receiving UE 110. When the resource reservation in the future slot is not provided in a first transmission, the transmitting UE 110 may request or trigger HARQ feedback transmission through a standalone message or a second transmission, sent after a first transmission that the transmitting UE 110 wants to receive feedback. In one example, the transmitting UE may transmit the standalone message or the second transmission after the transmitting succeeds the channel access for the transmission.

For example, the HARQ feedback transmission slot may not be previously reserved by the transmitting UE 110. In this example, when transmitting in a slot (e.g., n+k), the transmitting UE 110 may indicate that HARQ feedback is requested for a previous transmission (e.g., in slot n). In one case, the receiving UE 110 may then, in response to the HARQ feedback request, transmit the HARQ feedback corresponding to a previous transmission(s) from the transmitting UE 110.

In another case, the receiving UE 110 may transmit the HARQ feedback to a previous transmission(s) with a specific HARQ process identification (ID) from the transmitting UE 110. For example, the receiving UE 110 may transmit the HARQ feedback to data transmission(s) from the transmitting UE 110 having the same HARQ process ID as that indicated in slot n+k.

In another example, the transmitting UE 110 may transmit a standalone signal (e.g., control signal) requesting HARQ feedback for a previous transmission. For example, the transmitting UE transmits data transmission in slot n, and transmits the standalone control signal in slot n+k requesting or triggering the HARQ feedback transmission; the receiving UE transmits the HARQ feedback in slot n+k following the control signal transmission. In an example, the standalone signal may be a control signal (e.g., SCI) or a triggering signal.

In some aspects, the HARQ timeline may not be fixed. For example, the value k may not have a pre-defined value, which depends on the transmitting UE resource reservation/indication and/or channel access/LBT. Instead, the HARQ timeline may be specified, for example, within a range. In other words, the HARQ feedback to a data transmission may be transmitted in a time window, not earlier/later than the boundaries specified by a window, or within a COT (e.g., HARQ feedback acknowledging data transmissions in the same COT). In some examples, k may be greater than a threshold thereby k has a lower boundary but no upper boundary.

Regarding option 3, k may be a fixed timeline after n. For example, a HARQ feedback transmission may have a pre-determined timeline. The HARQ feedback timeline may be specified to be n+k. For a data transmission in slot n, the HARQ feedback may be transmitted in slot n+k, where k has a fixed value. In this example, if the transmitting UE 110 requests a HARQ feedback transmission in slot n, the transmitting UE 110 also transmits in slots n+1, . . . , n+k. Because the transmitting UE 110 keeps the medium continuously occupied, a CAT 4 LBT may not be needed for the HARQ feedback transmission. In an example, a continuously occupied medium may mean no gaps between transmissions (e.g., first and second transmissions or data and feedback transmissions) or a gap between transmissions having a duration smaller than a threshold.

Referring to the feedback technique 600, as an example, when k=1, the transmitting UE 110 may transmit a sidelink data transmission (e.g., TB1 602) in slot n 620, and transmit another sidelink data transmission (e.g., TB2 604) in slot n+1 622, prior to the HARQ feedback transmission. The HARQ feedback 606 for TB1 602 may be transmitted in slot n+1 622, following reception of the TB2 604. In some examples, the receiving UE 110 may transmit HARQ feedback 606 based on an indication from the transmitting UE. For example, the transmitting UE 110 may request a HARQ feedback 606 (e.g., in control signaling) when transmitting the TB1 602 (e.g., if it has contiguous transmissions that last to slot n+1 622), then the receiving UE 110 knows that it can transmit the HARQ feedback 606 in the slot n+1 622.

In an aspect, the receiving UE 110 may transmit a HARQ feedback based on a Type 2 channel access. The channel access type may be a Type 2A (e.g., a sensing duration of 25 us), a Type 2B (e.g., a sensing duration of 16 us), or a Type 2C (e.g., no sensing). The channel access type for the HARQ feedback transmission may be configured, pre-configured, or indicated by the transmitting UE 110. For example, when enabling, requesting, or triggering a HARQ feedback, the transmitting UE 110 also may indicate the channel access type.

Referring to the feedback technique 650, an example of a slot n+k 652 (e.g., second slot 522 or third slot 524 of FIG. 5), or a PSFCH slot, is illustrated. In this aspect, the slot n+k 652 includes data transmission 654 from a transmitting UE 110, a gap 656, and a feedback transmission 658 (e.g., HARQ feedback). In an example, for the data transmission 654 (e.g., standalone control signal transmission) and the feedback transmission 658 in the slot n+k 652, there may be the gap 656 between them. In an example, the gap 656 may have a pre-determined duration (e.g., 16 μs). In another example, the gap 656 duration may be implied or indicated by the transmitting UE 110. For example, when the transmitting UE 110 indicates a Type 2B channel access for a the feedback transmission 658, the transmitting UE 110 may imply that the gap 656 is a 16 μs gap preceding the feedback transmission 658.

In another aspect, when transmitting the HARQ feedback based on Type 2A/2B channel access, the receiving UE 110 may transmit HARQ feedback if sensing in the channel access indicates that the channel is idle for transmission (e.g., energy detection in the gap is below an energy threshold).

In another aspect, the frequency resource used for a HARQ feedback transmission may be implied by the transmitting UE transmission. For example, the HARQ feedback (e.g., PSFCH) transmission may be in the same (or part of) a frequency resource that is used by the transmitting UE 110 in slot n+k.

Use of the techniques provided herein may allow the slot n+k to have a signal (e.g., data) transmission from the same transmitting UE 110, may allow the receiving UE 110 to transmit HARQ feedback following the transmission from the transmitting UE 110, and may allow at least CAT 4 LBT (e.g., Type 1 channel access) to be waived for the HARQ feedback transmission, if the transmission from the transmitting UE 110 in the slot n+k and receiving UE HARQ feedback transmission in the slot n=k is no larger than a threshold (e.g., 25 μs). The techniques also allow the receiving UE to have sufficient time to perform receiver processing (e.g., decoding) of the received transmission in slot n. Further, the HARQ feedback transmission probability and system performance may be improved due to waiving (CAT 4) LBT.

In an aspect, the HARQ feedback can be an ACK/NACK feedback, that is, the receiving UE 110 may transmit an ACK indicating that a decoding of the data transmission from the transmitting UE 110 in slot n was successful. Otherwise, the receiving UE 110 transmits a NACK.

In another aspect, the HARQ feedback can be a NACK-only feedback, that is, the receiving UE 110 may only transmit HARQ feedback (e.g., NACK) when the receiving UE 110 is unable to decode the data transmission from the transmitting UE 110 in slot n. Otherwise, the receiving UE 110 transmits no HARQ feedback.

In another aspect, the receiving UE 110 may miss the data transmission from the transmitting UE 110 in slot n, for example, the receiving UE 110 decodes nothing (e.g., neither control signaling nor data channel) in slot n, due to bad channel condition, but receives signaling in slot n+k requesting HARQ feedback. In this case, the receiving UE 110 may transmit NACK in slot n+k.

In another aspect, the second transmission/standalone control signal and the HARQ feedback transmission may not be in the same slot. For example, the second transmission or the standalone control signal transmission may happen in slot n+k, the HARQ feedback transmission may then happen in slot n+k+1 (which may occupy all the available symbols in slot n+k+1), where transmission in slot n+k lasts until an end of the slot. In this case, the HARQ feedback transmission may start from beginning of slot n+k+1. Although these transmissions are distributed in two slots, the transmissions may still be physically continuous, and a Type 1 channel access may be exempted.

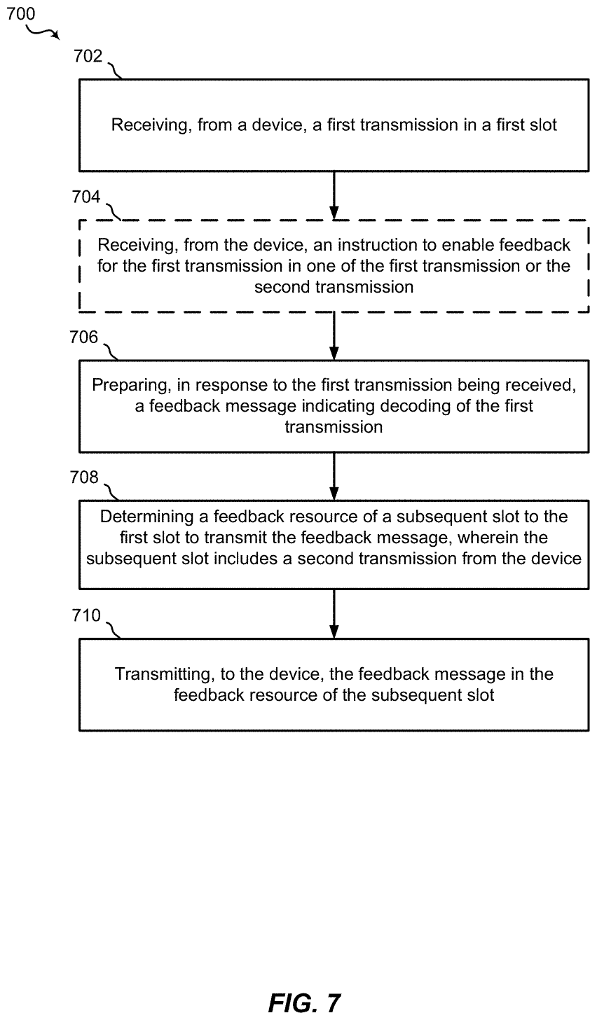

Referring to FIG. 7, an example of a method 700 for sidelink HARQ feedback transmissions in unlicensed spectrums may be performed by the sidelink HARQ receiving component 142, the modem 140, the transceiver 202, the processor 212, and/or the memory 216 of the UE 110 of the wireless communication network 100.

At block 702, the method 700 may include receiving, from a device, a first transmission in a first slot. For example, the sidelink HARQ receiving component 142, the modem 140, the transceiver 202, the processor 212, and/or the memory 216 of the UE 110, and/or one or more additional components/subcomponents of the UE 110 may be configured to or may comprise means for receiving, from a device, a first transmission in a first slot.

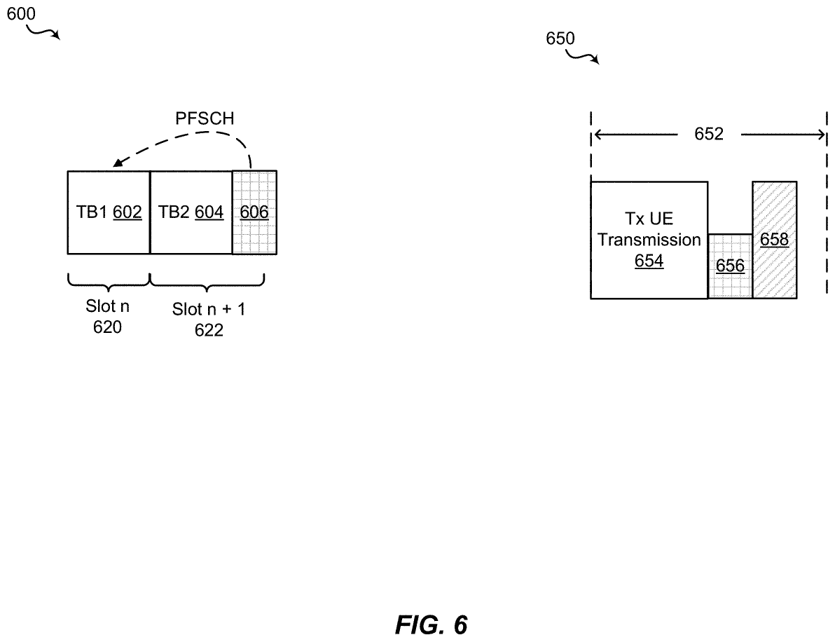

For example, the receiving of the first transmission at the block 702 may include receiving by the sidelink HARQ receiving component 142, the modem 140, the transceiver 202, the processor 212, and/or the memory 216 of the UE 110, via the antenna 265, the RF front end 288, and/or the transceiver 202, a data transmission from a transmitting UE 110. Examples of the data transmission may include, for example, the first transmission 502 of the first slot 520 of FIG. 5 or the TB1 602 of slot n of FIG. 6.

At block 704, the method 700 may optionally include receiving, from the device, an instruction to enable feedback for the first transmission in one or more of the first transmission or the second transmission. For example, the sidelink HARQ receiving component 142, the modem 140, the transceiver 202, the processor 212, and/or the memory 216 of the UE 110, and/or one or more additional components/subcomponents of the UE 110 may be configured to or may comprise means for receiving, from the device, an instruction to enable feedback for the first transmission in one or more of the first transmission or the second transmission.

For example, the receiving of the instruction at block 704 may include receiving by the sidelink HARQ receiving component 142, the modem 140, the transceiver 202, the processor 212, and/or the memory 216 of the UE 110, via the antenna 265, the RF front end 288, and/or the transceiver 202, an indication to enable or requesting feedback, corresponding to the first transmission, from a transmitting UE 110. In an example, feedback may be enabled or requested in the first transmission 502 of the first slot 520 of FIG. 5 or the TB1 602 of slot n of FIG. 6. In an example, enablement or requesting of feedback by the transmitting UE 110 may be indicated by one or more bits or a message.

At block 706, the method 700 may include preparing, in response to the first transmission being received, a feedback message indicating decoding of the first transmission. For example, the sidelink HARQ receiving component 142, the modem 140, the processor 212, and/or the memory 216 of the UE 110, and/or one or more additional components/subcomponents of the UE 110 may be configured to or may comprise means for preparing, in response to the first transmission being received, a feedback message indicating decoding of the first transmission.

For example, the preparing of the feedback message at block 706 may include preparing by the sidelink HARQ receiving component 142, the modem 140, the processor 212, and/or the memory 216 of the UE 110 the HARQ feedback 512 or HARQ feedback 606 which indicates decoding of the first transmission 502 of the first slot 520 of FIG. 5 or the TB1 602 of slot n of FIG. 6. In example, preparing the feedback message may include coding the feedback message for transmission to the transmitting UE 110. By preparing the feedback message, the receiving UE 110 may be prepared to transmit the feedback message before reception of a request or a trigger for feedback.

At block 708, the method 700 may include determining a feedback resource of a subsequent slot to the first slot to transmit the feedback message. For example, the sidelink HARQ receiving component 142, the modem 140, the processor 212, and/or the memory 216 of the UE 110, and/or one or more additional components/subcomponents of the UE 110 may be configured to or may comprise means for determining a feedback resource of a subsequent slot to the first slot to transmit the feedback message.

For example, the determining of the feedback resource at block 708 may include determining by the sidelink HARQ receiving component 142, the modem 140, the processor 212, and/or the memory 216 of the UE 110 a feedback resource of a subsequent slot to the first slot, such as the second transmission 504 of the second slot 522 of FIG. 5 or the TB2 604 of the slot n+1 of FIG. 6 to transmit the feedback message (e.g., HARQ feedback 512 or HARQ feedback 606. By determining the feedback resource of the subsequent slot, the receiving UE 110 may transmit the feedback message within the same slot as a subsequent transmission from the transmitting UE 110 in the subsequent slot.

In an example, the determining of the feedback resource at block 706 may be in response to receiving a second transmission (e.g., second transmission 504 or TB2 604) from the transmitting UE 110. In some examples, the second transmission may be received in the subsequent slot (e.g., second slot 522 or slot n+1 622). In some examples, the second transmission may signal to the receiving UE 110 to transmit the feedback message. In some examples, the feedback resource is determined in response to a resource indication indicating the feedback resource for the transmitting of the feedback message being identified from the first transmission. In some examples, the subsequent slot is a fixed number of slots after the first slot.

At block 710, the method 700 may include transmitting, to the device, the feedback message in the feedback resource of the subsequent slot. For example, the sidelink HARQ receiving component 142, the modem 140, the transceiver 202, the processor 212, and/or the memory 216 of the UE 110, and/or one or more additional components/subcomponents of the UE 110 may be configured to or may comprise means for transmitting, to the device, the feedback message in the feedback resource of the subsequent slot.

For example, the transmitting at block 710 may include transmitting by the sidelink HARQ receiving component 142, the modem 140, the transceiver 202, the processor 212, and/or the memory 216 of the UE 110, via the antenna 265, the RF front end 288, and/or the transceiver 202, the HARQ feedback 512 or the HARQ feedback 606 in the feedback resource of the second slot 522 of FIG. 5 or the slot n+1 of FIG. 6. Transmission of the feedback message in the same slot as the second transmission allows the receiving UE 110 to avoid LBT requirements of unlicensed spectrums which can add uncertainty in feedback transmissions, as described herein.

In some aspects, the feedback message may be in a same frequency resource, or part of the same frequency resource, of the subsequent slot used by the device.

In some aspects, the method 700 may include determining an indication of a range of slots after the first slot that correspond to the subsequent slot. For example, the sidelink HARQ receiving component 142, the modem 140, the transceiver 202, the processor 212, and/or the memory 216 of the UE 110, and/or one or more additional components/subcomponents of the UE 110 may be configured to or may comprise means for determining an indication of a range of slots after the first slot that correspond to the subsequent slot. In an example, the indication of the range of slots may be received from the transmitting UE 110, or determined based on a setting or configuration of the receiving UE 110.

For example, the receiving of the indication of the range of slots may include receiving by the sidelink HARQ receiving component 142, the modem 140, the transceiver 202, the processor 212, and/or the memory 216 of the UE 110, via the antenna 265, the RF front end 288, and/or the transceiver 202, an indication of a range of slots after the first slot that correspond to the subsequent slot.

In some aspects, the method 700 may include performing channel access. For example, the sidelink HARQ receiving component 142, the modem 140, the processor 212, and/or the memory 216 of the UE 110, and/or one or more additional components/subcomponents of the UE 110 may be configured to or may comprise means for performing channel access.

For example, the performing the channel access may include performing by the sidelink HARQ receiving component 142, the modem 140, the transceiver 202, the processor 212, and/or the memory 216 of the UE 110, via the antenna 265, the RF front end 288, and/or the transceiver 202, a channel access.

In an example, a channel access type for the channel access is indicated in a message from the transmitting UE 110, based on a setting of the receiving UE 110, or implied by a configuration of communications between the receiving UE 110 and the transmitting UE 110.

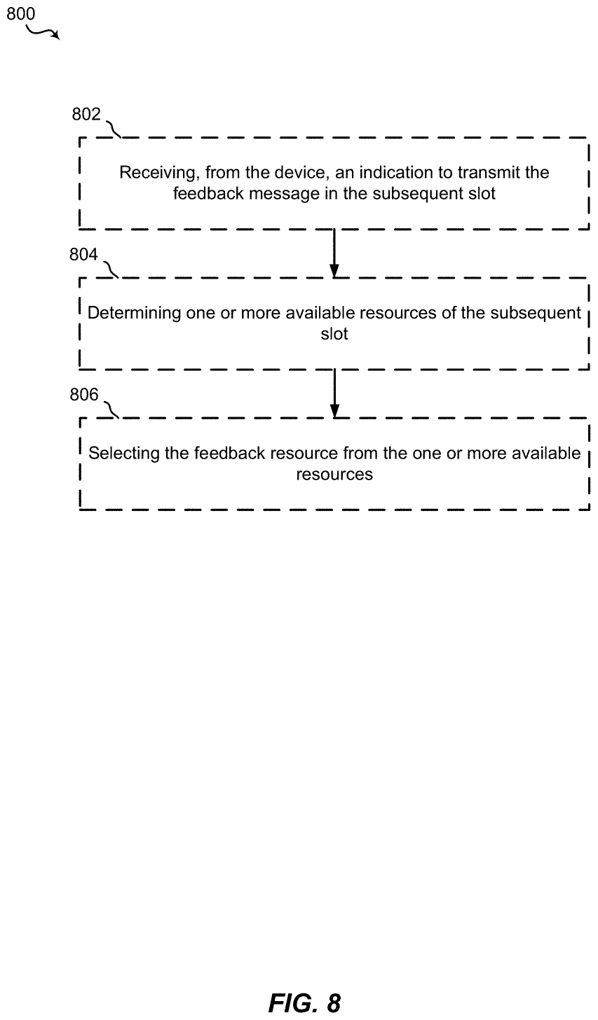

Referring to FIG. 8, the actions of block 708 may optionally include the method 800 to determine the feedback resource. The method 800 may include, at block 802, receiving, from the device, an indication to transmit the feedback message in the subsequent slot. For example, the sidelink HARQ receiving component 142, the modem 140, the transceiver 202, the processor 212, and/or the memory 216 of the UE 110, and/or one or more additional components/subcomponents of the UE 110 may be configured to or may comprise means for receiving, from the device, an indication to transmit the feedback message in the subsequent slot.

For example, at the block 802, the sidelink HARQ receiving component 142, the modem 140, the transceiver 202, the processor 212, and/or the memory 216 of the UE 110, and/or one or more additional components/subcomponents of the UE 110, via the antenna 265, the RF front end 288, and/or the transceiver 202, may receive, from the transmitting UE 110, an indication to transmit the feedback message (e.g., first transmission 502 or TB1 602) in the subsequent slot (e.g., second slot 522 or slot n+1 622).

In some examples, the indication may be indicated in one of a data transmission of the subsequent slot (e.g., second slot 522 or slot n+1 622), a control transmission corresponding to the subsequent slot, or a standalone message (e.g., standalone control message) from the transmitting UE 110.

The method 800, may include, at block 804, determining one or more available resources of the subsequent slot. For example, the sidelink HARQ receiving component 142, the modem 140, the processor 212, and/or the memory 216 of the UE 110, and/or one or more additional components/subcomponents of the UE 110 may be configured to or may comprise means for determining one or more available resources of the subsequent slot.

For example, the sidelink HARQ receiving component 142, the modem 140, the transceiver 202, the processor 212, and/or the memory 216 of the UE 110, and/or one or more additional components/subcomponents of the UE 110 may determine one or more available resources of the subsequent slot based on an indication in the first transmission 502 or TB1 602 of scheduled resources, or based on configuration of HARQ feedback resources.

The method 800, may include, at block 806, selecting the feedback resource from the one or more available resources. For example, the sidelink HARQ receiving component 142, the modem 140, the processor 212, and/or the memory 216 of the UE 110, and/or one or more additional components/subcomponents of the UE 110 may be configured to or may comprise means for selecting the feedback resource from the one or more available resources.

For example, the sidelink HARQ receiving component 142, the modem 140, the transceiver 202, the processor 212, and/or the memory 216 of the UE 110, and/or one or more additional components/subcomponents of the UE 110 may randomly select a resource from the one or more available resources to use as the feedback resource. In another example, the receiving UE may select a resource for the HARQ feedback transmission based on the transmitting UE ID, and/or the receiving UE ID.

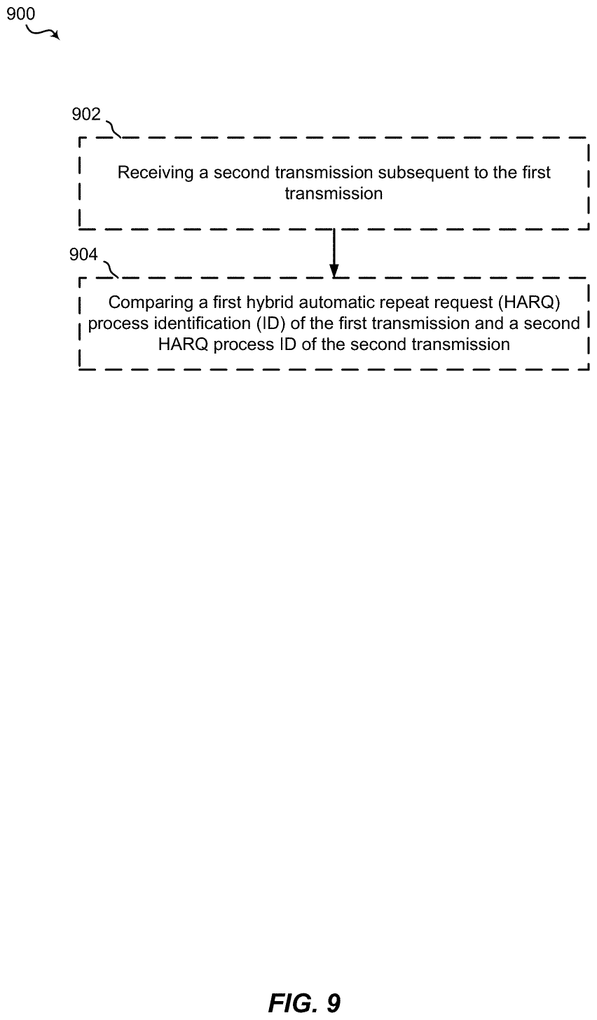

Referring to FIG. 9, the method 700 may optionally include the method 900 including, at block 902, receiving a second transmission subsequent to the first transmission. For example, the sidelink HARQ receiving component 142, the modem 140, the transceiver 202, the processor 212, and/or the memory 216 of the UE 110, and/or one or more additional components/subcomponents of the UE 110 may be configured to or may comprise means for receiving a second transmission subsequent to the first transmission.

For example, at the block 902, the sidelink HARQ receiving component 142, the modem 140, the transceiver 202, the processor 212, and/or the memory 216 of the UE 110, and/or one or more additional components/subcomponents of the UE 110, via the antenna 265, the RF front end 288, and/or the transceiver 202, may receive a second transmission (e.g., second transmission 504 or TB2 604) subsequent to the first transmission (e.g., first transmission 502 or TB1 602).

At block 904, the method 900 may include comparing a first HARQ process ID of the first transmission and a second HARQ process ID of the second transmission. For example, the sidelink HARQ receiving component 142, the modem 140, the processor 212, and/or the memory 216 of the UE 110, and/or one or more additional components/subcomponents of the UE 110 may be configured to or may comprise means for comparing a first HARQ process ID of the first transmission and a second HARQ process ID of the second transmission.

For example, at the block 904, the sidelink HARQ receiving component 142, the modem 140, the processor 212, and/or the memory 216 of the UE 110, and/or one or more additional components/subcomponents of the UE 110 may compare a first HARQ process ID of the first transmission (e.g., first transmission 502 or TB1 602) and a second HARQ process ID of the second transmission (e.g., second transmission 504 or TB2 604). In an aspect, a HARQ process ID may be associated with each data channel transmission. In an example, the HARQ process ID may be carried in a control signal of the transmission. The HARQ process ID allows the transmitting UE 110 to have multiple parallel HARQ processes performed, while keeping track of each of the HARQ processes as the HARQ feedback transmission always follows the same HARQ process.

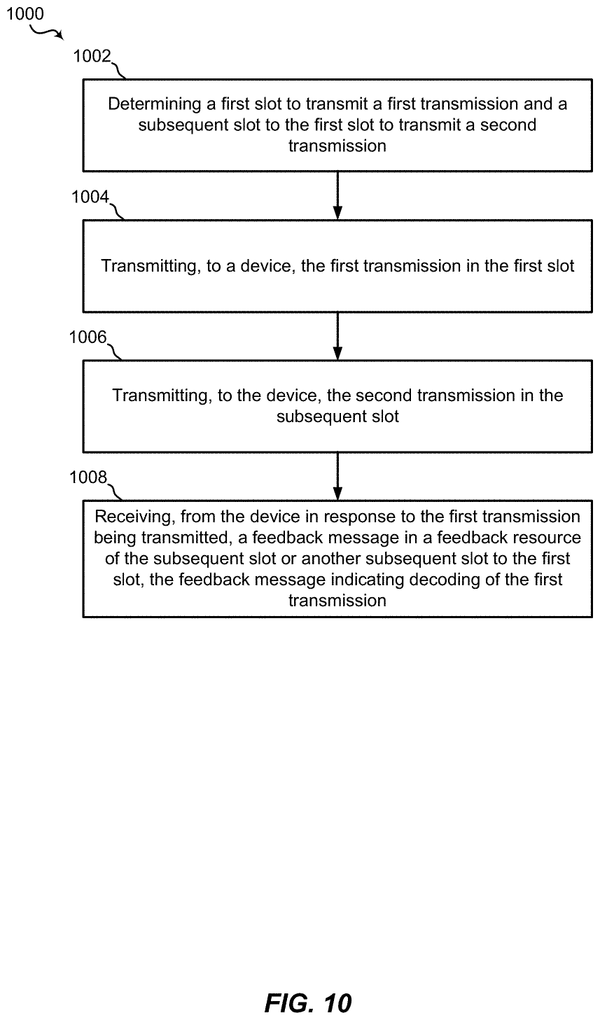

Referring to FIG. 10, an example of a method 1000 for sidelink HARQ feedback transmissions in unlicensed spectrums may be performed by the sidelink HARQ transmitting component 144, the modem 140, the transceiver 202, the processor 212, and/or the memory 216 of the UE 110 of the wireless communication network 100.

At block 1002, the method 1000 may include determining a first slot to transmit a first transmission and a subsequent slot to the first slot to transmit a second transmission. For example, the sidelink HARQ transmitting component 144, the modem 140, the processor 212, and/or the memory 216 of the UE 110, and/or one or more additional components/subcomponents of the UE 110 may be configured to or may comprise means for determining a first slot to transmit a first transmission and a subsequent slot to the first slot to transmit a second transmission.

For example, the determining of the first slot and a subsequent slot at the block 1002 may include determining by the sidelink HARQ transmitting component 144, the modem 140, the processor 212, and/or the memory 216 of the UE 110, the first slot and the subsequent slot based on one nor more of availability of slots and resources of the slots, processing time for a receiving UE 110 to decode data of the first transmission, and/or one or more resource management settings.

In some examples, the first transmission also includes an indication of the subsequent slot and/or a resource of the subsequent slot for the device to transmit the feedback message.

At block 1004, the method 1000 may include transmitting, to a device, the first transmission in the first slot. For example, the sidelink HARQ transmitting component 144, the modem 140, the transceiver 202, the processor 212, and/or the memory 216 of the UE 110, and/or one or more additional components/subcomponents of the UE 110 may be configured to or may comprise means for transmitting, to the device, the first transmission in the first slot.

For example, the transmitting of the first transmission at the block 1004 may include transmitting by the sidelink HARQ transmitting component 142, the modem 140, the transceiver 202, the processor 212, and/or the memory 216 of the UE 110, via the antenna 265, the RF front end 288, and/or the transceiver 202, the first transmission 502 in the first slot 520 or the TB1 602 in the slot n+k 620.

At block 1006, the method 1000 may include transmitting, to the device, the second transmission in the subsequent slot. For example, the sidelink HARQ transmitting component 144, the modem 140, the transceiver 202, the processor 212, and/or the memory 216 of the UE 110, and/or one or more additional components/subcomponents of the UE 110 may be configured to or may comprise means for transmitting, to the device, the second transmission in the subsequent slot.

For example, the transmitting of the second transmission at the block 1006 may include transmitting by the sidelink HARQ transmitting component 142, the modem 140, the transceiver 202, the processor 212, and/or the memory 216 of the UE 110, via the antenna 265, the RF front end 288, and/or the transceiver 202, the second transmission 504 in the second slot 522 or the TB2 604 in the slot n+1 622.

At block 1008, the method 1000 may include receiving, from the device in response to the first transmission being transmitted, a feedback message in a feedback resource of the subsequent slot or another subsequent slot to the first slot, the feedback message indicating decoding of the first transmission. For example, the sidelink HARQ transmitting component 144, the modem 140, the transceiver 202, the processor 212, and/or the memory 216 of the UE 110, and/or one or more additional components/subcomponents of the UE 110 may be configured to or may comprise means for receiving, from the device in response to the first transmission being transmitted, a feedback message in a feedback resource of the subsequent slot or another subsequent slot to the first slot, the feedback message indicating decoding of the first transmission.

For example, the receiving of the feedback message at the block 1008 may include receiving by the sidelink HARQ transmitting component 142, the modem 140, the transceiver 202, the processor 212, and/or the memory 216 of the UE 110, via the antenna 265, the RF front end 288, and/or the transceiver 202, the HARQ feedback 512 or the HARQ feedback 606.

In some aspects, the method 1000 may optionally include transmitting, to the device, an indication to transmit the feedback message in the subsequent slot, wherein the receiving of the feedback message is in response to the transmitting of the indication. For example, the sidelink HARQ transmitting component 144, the modem 140, the transceiver 202, the processor 212, and/or the memory 216 of the UE 110, and/or one or more additional components/subcomponents of the UE 110 may be configured to or may comprise means for transmitting, to the device, an indication to transmit the feedback message in the subsequent slot, wherein the receiving of the feedback message is in response to the transmitting of the indication.

For example, the transmitting of the indication may include transmitting by the sidelink HARQ transmitting component 142, the modem 140, the transceiver 202, the processor 212, and/or the memory 216 of the UE 110, via the antenna 265, the RF front end 288, and/or the transceiver 202, the indication to transmit the HARQ feedback 512 or the HARQ feedback 606 in the second slot 522 or the slot n+1 622. In an example, the indication may and provide a trigger for the receiving UE 110 to know that the transmitting UE 110 wants feedback and/or when to transmit the feedback. In another example, the indication may be transmitted to the receiving UE 110 in the second slot 522 or the slot n+1 622 or, alternatively, in a standalone message.

In some aspects, the method 1000 may optionally include transmitting an indication of a range of slots after the first slot that correspond to the subsequent slot. For example, the sidelink HARQ transmitting component 144, the modem 140, the transceiver 202, the processor 212, and/or the memory 216 of the UE 110, and/or one or more additional components/subcomponents of the UE 110 may be configured to or may comprise means for transmitting an indication of a range of slots after the first slot that correspond to the subsequent slot.

In some aspects, the method 1000 may optionally include maintaining continuous transmissions between the first slot and the subsequent slot. For example, the sidelink HARQ transmitting component 144, the modem 140, the transceiver 202, the processor 212, and/or the memory 216 of the UE 110, and/or one or more additional components/subcomponents of the UE 110 may be configured to or may comprise means for maintaining continuous transmissions between the first slot and the subsequent slot. In an example, maintaining continuous transmissions may mean that transmissions do not include a gap between the transmissions (e.g., first and second transmissions or data and feedback transmissions) or a gap duration is smaller than a threshold. By maintaining continuous transmissions, the transmitting UE 110 may allow the receiving UE 110 to avoid LBT requirements.

In some aspects, the method 1000 may optionally include transmitting, to the device, an indication of a channel access type for the feedback message, wherein the receiving of the feedback message is in response to the channel access type. For example, the sidelink HARQ transmitting component 144, the modem 140, the transceiver 202, the processor 212, and/or the memory 216 of the UE 110, and/or one or more additional components/subcomponents of the UE 110 may be configured to or may comprise means for transmitting, to the device, an indication of a channel access type for the feedback message, wherein the receiving of the feedback message is in response to the channel access type.

### Additional Implementations

An example method of wireless communication by a user equipment (UE), comprising: receiving, from a device, a first transmission in a first slot; preparing, in response to the first transmission being received, a feedback message indicating decoding of the first transmission; determining a feedback resource of a subsequent slot to the first slot to transmit the feedback message; and transmitting, to the device, the feedback message in the feedback resource of the subsequent slot.

The above example method, wherein the determining of the feedback resource is in response to receiving a second transmission from the device.

One or more of the above example methods, wherein the second transmission is received in the subsequent slot.

One or more of the above example methods, wherein the second transmission indicates to the UE to transmit the feedback message.

One or more of the above example methods, wherein the determining of the feedback resource is in response to a resource indication indicating the feedback resource for the transmitting of the feedback message being identified from the first transmission.

One or more of the above example methods, further comprising: receiving, from the device, an instruction to enable feedback for the first transmission in one or more of the first transmission or a second transmission.

One or more of the above example methods, wherein the determining of the feedback resource comprises: receiving, from the device, an indication to transmit the feedback message in the subsequent slot; determining one or more available resources of the subsequent slot; and selecting the feedback resource from the one or more available resources.

One or more of the above example methods, wherein the indication is indicated in one or more of a data transmission of the subsequent slot, a control channel corresponding to the data transmission of the subsequent slot, or a standalone message from the device.

One or more of the above example methods, further comprising: receiving a second transmission subsequent to the first transmission; and comparing a first hybrid automatic repeat request (HARQ) process identification (ID) of the first transmission and a second HARQ process ID of the second transmission, wherein the transmitting of the feedback message is in response to the first HARQ process ID matching the second HARQ process ID.

One or more of the above example methods, further comprising: determining an indication of a range of slots after the first slot that correspond to the subsequent slot.

One or more of the above example methods, wherein the subsequent slot is a fixed number of slots after the first slot.

One or more of the above example methods, further comprising: performing channel access, wherein the transmitting of the feedback message is in response to the channel access.

One or more of the above example methods, wherein a channel access type for the channel access is indicated in a message from the device, based on a setting of the UE, or implied by a configuration of communications between the UE and the device.

One or more of the above example methods, wherein the feedback message may be in a same frequency resource, or part of the same frequency resource, of the subsequent slot used by the device.

An example apparatus, comprising: a memory comprising instructions; and one or more processors communicatively coupled with the memory and configured to: perform all or a part of any of the above example methods.

An example computer readable medium having instructions stored therein that, when executed by one or more processors, cause the one or more processors to: perform all or a part of any of the above example methods.

An example apparatus, comprising: means for performing all or a part of any of the above example methods.

A second example method of wireless communication by a user equipment (UE), comprising: determining a first slot to transmit a first transmission and a subsequent slot to the first slot to transmit a second transmission; transmitting, to a device, the first transmission in the first slot; transmitting, to the device, the second transmission in the subsequent slot; and receiving, from the device in response to the first transmission being transmitted, a feedback message in a feedback resource of the subsequent slot or another subsequent slot to the first slot, the feedback message indicating decoding of the first transmission.

The second example method above, wherein the determining of the subsequent slot is based on a processing time for the device to decode the first transmission.

One or more of the above second example methods, wherein the subsequent slot for the device to transmit the feedback message is indicated in the first transmission.

One or more of the above second example methods, wherein the first transmission further indicates a resource of the subsequent slot for the device to transmit the feedback message.

One or more of the above second example methods, further comprising: transmitting, to the device, an indication to transmit the feedback message in the subsequent slot, wherein the receiving of the feedback message is in response to the transmitting of the indication.

One or more of the above second example methods, wherein the indication is indicated in one or more of a data transmission of the subsequent slot, a control channel corresponding to the data transmission of the subsequent slot, or a standalone message from the device.

One or more of the above second example methods, further comprising: transmitting an indication of a range of slots after the first slot that correspond to the subsequent slot.

One or more of the above second example methods, further comprising: maintaining continuous transmissions between the first slot and the subsequent slot.

One or more of the above second example methods, further comprising: transmitting, to the device, an indication of a channel access type for the feedback message, wherein the receiving of the feedback message is in response to the channel access type.

Another example apparatus, comprising: a memory comprising instructions; and one or more processors communicatively coupled with the memory and configured to: perform any of the one or more above second methods.

Another example computer readable medium having instructions stored therein that, when executed by one or more processors, cause the one or more processors to: perform any of the one or more above second methods.

Another example apparatus, comprising: means for performing any of the one or more above second methods.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication by a user equipment (UE), comprising:
receiving, from a device, a first transmission in a first slot;
preparing, in response to the first transmission being received, a feedback message indicating decoding of the first transmission;
determining a feedback resource of a subsequent slot to the first slot to transmit the feedback message; and
transmitting, to the device, the feedback message in the feedback resource of the subsequent slot.

2. The method of claim 1, wherein the determining of the feedback resource is in response to receiving a second transmission from the device.

3. The method of claim 2, wherein the second transmission is received in the subsequent slot.

4. The method of claim 2, wherein the second transmission indicates to the UE to transmit the feedback message.

5. The method of claim 1, wherein the determining of the feedback resource is in response to a resource indication indicating the feedback resource for the transmitting of the feedback message being identified from the first transmission.

6. The method of claim 1, further comprising:
receiving, from the device, an instruction to enable feedback for the first transmission in one or more of the first transmission or a second transmission.

7. The method of claim 1, wherein the determining of the feedback resource comprises:
receiving, from the device, an indication to transmit the feedback message in the subsequent slot;
determining one or more available resources of the subsequent slot; and
selecting the feedback resource from the one or more available resources.

8. The method of claim 7, wherein the indication is indicated in one or more of a data transmission of the subsequent slot, a control channel corresponding to the data transmission of the subsequent slot, or a standalone message from the device.

9. The method of claim 1, further comprising:
receiving a second transmission subsequent to the first transmission; and
comparing a first hybrid automatic repeat request (HARQ) process identification (ID) of the first transmission and a second HARQ process ID of the second transmission,
wherein the transmitting of the feedback message is in response to the first HARQ process ID matching the second HARQ process ID.

10. The method of claim 1, further comprising:
determining an indication of a range of slots after the first slot that correspond to the subsequent slot.

11. The method of claim 1, wherein the subsequent slot is a fixed number of slots after the first slot.

12. The method of claim 1, further comprising:
performing channel access, wherein the transmitting of the feedback message is in response to the channel access.

13. The method of claim 12, wherein a channel access type for the channel access is indicated in a message from the device, based on a setting of the UE, or implied by a configuration of communications between the UE and the device.

14. The method of claim 1, wherein the feedback message may be in a same frequency resource, or part of the same frequency resource, of the subsequent slot used by the device.

15. A method of wireless communication by a user equipment (UE), comprising:
determining a first slot to transmit a first transmission and a subsequent slot to the first slot to transmit a second transmission;
transmitting, to a device, the first transmission in the first slot;
transmitting, to the device, the second transmission in the subsequent slot; and
receiving, from the device in response to the first transmission being transmitted, a feedback message in a feedback resource of the subsequent slot or another subsequent slot to the first slot, the feedback message indicating decoding of the first transmission.

16. The method of claim 15, wherein the determining of the subsequent slot is based on a processing time for the device to decode the first transmission.

17. The method of claim 15, wherein the subsequent slot for the device to transmit the feedback message is indicated in the first transmission.

18. The method of claim 17, wherein the first transmission further indicates a resource of the subsequent slot for the device to transmit the feedback message.

19. The method of claim 15, further comprising:
transmitting, to the device, an indication to transmit the feedback message in the subsequent slot, wherein the receiving of the feedback message is in response to the transmitting of the indication.

20. The method of claim 19, wherein the indication is indicated in one or more of a data transmission of the subsequent slot, a control channel corresponding to the data transmission of the subsequent slot, or a standalone message from the device.

21. The method of claim 15, further comprising:
transmitting an indication of a range of slots after the first slot that correspond to the subsequent slot.

22. The method of claim 15, further comprising:
maintaining continuous transmissions between the first slot and the subsequent slot.

23. The method of claim 15, further comprising:
transmitting, to the device, an indication of a channel access type for the feedback message, wherein the receiving of the feedback message is in response to the channel access type.

24. A user equipment (UE), comprising:
a memory storing instructions; and
one or more processors coupled with the memory and configured to:
receive, from a device, a first transmission in a first slot;
prepare, in response to the first transmission being received, a feedback message indicating decoding of the first transmission;
determine a feedback resource of a subsequent slot to the first slot to transmit the feedback message; and
transmit, to the device, the feedback message in the feedback resource of the subsequent slot.

25. The UE of claim 24, wherein the feedback resource is determined in response to a second transmission from the device being received.

26. The UE of claim 25, wherein the second transmission is received in the subsequent slot.

27. The UE of claim 25, wherein the second transmission indicates to the UE to transmit the feedback message.

28. A user equipment (UE), comprising:
a memory storing instructions; and
one or more processors coupled with the memory and configured to:
determine a first slot to transmit a first transmission and a subsequent slot to the first slot to transmit a second transmission;
transmit, to a device, the first transmission in the first slot;
transmit, to the device, the second transmission in the subsequent slot; and
receive, from the device in response to the first transmission being transmitted, a feedback message in a feedback resource of the subsequent slot or another subsequent slot to the first slot, the feedback message indicating decoding of the first transmission.

29. The UE of claim 28, wherein the subsequent slot is determined based on a processing time for the device to decode the first transmission.

30. The UE of claim 28, wherein the subsequent slot for the device to transmit the feedback message is indicated in the first transmission.
